(19) United States
(12) Patent Application Publication
(10) Pub. No.: US 2013/0271429 A1
(43) Pub. Date: Oct. 17, 2013

(54) TOUCH-CONTROL SYSTEM

(71) Applicant: Pixart Imaging Inc., Hsinchu City (TW)

(72) Inventors: TZUNG-MIN SU, HSINCHU CITY (TW); CHIH-HSIN LIN, HSINCHU CITY (TW); MING-TSAN KAO, HSINCHU CITY (TW)

(21) Appl. No.: 13/912,192

(22) Filed: Jun. 6, 2013

Related U.S. Application Data
(63) Continuation-in-part of application No. 12/899,234, filed on Oct. 6, 2010.

(30) Foreign Application Priority Data
Aug. 3, 2012 (TW) 101127934
Jan. 9, 2013 (TW) 102100746

(51) Int. Cl. G06F 3/042

(52) U.S. Cl. CPC G06F 3/0421
USPC 345/175

(57) ABSTRACT

A touch-control system adapted to be used with a plurality of pointers is provided. The touch-control system includes a touch-control panel, a first pointer sensing module, a second pointer sensing module and a processing circuit. The first pointer sensing module is configured to sense a first set of image information of the pointers and accordingly calculate a first candidate coordinate group of the pointers. The second pointer sensing module is configured to sense a second set of image information of the pointers. The processing circuit is electrically coupled to the first and second pointer sensing modules and configured to select, according to the second set of image information, two or more coordinate positions in the first candidate coordinate group to as actual coordinate positions of the pointers.

### CROSS REFERENCE TO RELATED APPLICATIONS

This application is a continuation-in-part application of U.S. patent application Ser. No. 12/899,234, filed on Oct. 6, 2010, the disclosure of which is incorporated herein by reference.

### TECHNICAL FIELD

The present invention relates to an optical touch technology, and more particularly to a touch-control system.

### BACKGROUND

FIG. 1 is a schematic view of a conventional touch-control system. As shown, the conventional touch-control system 10 includes a touch-control panel 100, two image sensing apparatuses 110, 120 and a processing circuit 130. The touch-control panel 100 has a quadrilateral structure, which is defined by a first side 101, a second side 102, a third side 103 and a fourth side 104 sequentially connected. Specifically, the image sensing apparatus 110 is disposed in a corner resulted by the first side 101 and the fourth side 104 of the touch-control panel 100; and the image sensing apparatus 120 is disposed in a corner resulted by the first side 101 and the second side 102 of the touch-control panel 100. The image sensing apparatus 110 is configured to sense a pointer 106 along a sensing path 112; and the image sensing apparatus 120 is configured to sense the pointer 106 along a sensing path 122. The processing circuit 130, electrically coupled to the image sensing apparatuses 110, 120, is configured to calculate the actual coordinate position of the pointer 106 based on the pointer images sensed by the two image sensing apparatuses 110, 120. That is, the processing circuit 130 can determine the actual coordinate position of the pointer 106 by calculating the crossing point of the two sensing paths 112, 122. However, some issues may occur if the touch-control system 10 is used for a multi touch; and the occurrence of these issues, resulted by the multi touch, will be described in FIG. 2.

FIG. 2 is a schematic view illustrating the touch-control system 10 used for a multi touch; wherein a two-point touch is took as an example herein and the objects in FIGS. 1, 2 labeled with the same number (or mark) represent one same device (or, element, apparatus). As shown in FIG. 2, the image sensing apparatus 110 is configured to sense the pointers 206, 208 along the sensing paths 212, 214, respectively; and the image sensing apparatus 120 is configured to sense the pointers 206, 208 along the sensing paths 222, 224, respectively. However, due to the processing circuit 130 is configured to determine the coordinate positions of the pointers 206, 208 based on the crossing points resulted by the sensing paths 212, 214, 222 and 224, the positions indicated by labels 216, 218 may be mistakenly determined as the actual positions of the pointers 206, 208 and accordingly the so-called ghost points are generated. Thus, the processing circuit 130 in the conventional touch-control system 10 fails to accurately determine the actual coordinate positions of the pointers 206, 208.

### SUMMARY OF EMBODIMENTS

The present invention provides a touch-control system capable of determine the actual coordinate position of a pointer without being affected by ghost points.

An embodiment of the present invention provides a touch-control system, which includes a touch-control panel, a first pointer sensing module, a second pointer sensing module and a processing circuit. The first pointer sensing module includes a first image sensing apparatus and a second image sensing apparatus. An extension line of a center of a sensing range of the first image sensing apparatus and that of the second image sensing apparatus are configured to have a first angle therebetween. The second pointer sensing module includes a first pointer sensing apparatus and a second pointer sensing apparatus. The first pointer sensing apparatus is disposed on a side of the touch-control panel. The second pointer sensing apparatus is disposed on a side of the touch-control panel. The extension line of the center of the sensing range of the first pointer sensing apparatus and that of the second pointer sensing apparatus are configured to have a second angle therebetween. The processing circuit is electrically coupled to the first and second pointer sensing modules. The processing circuit is configured to, when the touch-control panel is being touched by a first pointer and a second pointer, calculate possible coordinate positions of the first and second pointers according to pointer images sensed by the first pointer sensing module and thereby referring the calculated possible coordinate positions of the first and second pointers derived from the first pointer sensing module to as a first candidate coordinate group; the processing circuit is further configured to calculate possible coordinate positions of the first and second pointers according to pointer information sensed by the second pointer sensing module and thereby referring the calculated possible coordinate positions of the first and second pointers derived from the second pointer sensing module to as a second candidate coordinate group; and the processing circuit is further configured to obtain an intersection of the first and second candidate coordinate groups and thereby referring elements in the intersection to as the actual coordinate positions of the first and second pointers.

Another embodiment of the present invention provides a touch-control system adapted to be used with a plurality of pointers. The touch-control system includes a touch-control panel, a first pointer sensing module, a second pointer sensing module and a processing circuit. The first pointer sensing module is configured to sense a first set of image information of the pointers and accordingly calculate a first candidate coordinate group of the pointers. The second pointer sensing module is configured to sense a second set of image information of the pointers. The processing circuit is electrically coupled to the first and second pointer sensing modules and configured to select, according to the second set of image information, two or more coordinate positions in the first candidate coordinate group to as actual coordinate positions of the pointers.

In summary, by establishing a plurality of coordinate systems and accordingly generating respective candidate coordinate groups, the touch-control system of the present invention can efficiently distinguish the actual coordinate position of pointers from the ghost points through calculating the intersection of the candidate coordinate groups.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic view of a conventional touch-control system;

FIG. 2 is a schematic view illustrating the touch-control system shown in FIG. 1 used for a multi touch;

FIG. 3A is a schematic view of a touch-control system in accordance with the first embodiment of the present invention;

FIG. 3B is a schematic view illustrating one exemplary arrangement of the illuminating module and the illuminating apparatus;

FIG. 3C is a schematic view illustrating one exemplary arrangement of the illuminating module and the photosensitive apparatus;

FIG. 4 is a schematic view of a touch-control system in accordance with the second embodiment of the present invention; and

FIG. 5 is a schematic view of a touch-control system in accordance with the third embodiment of the present invention.

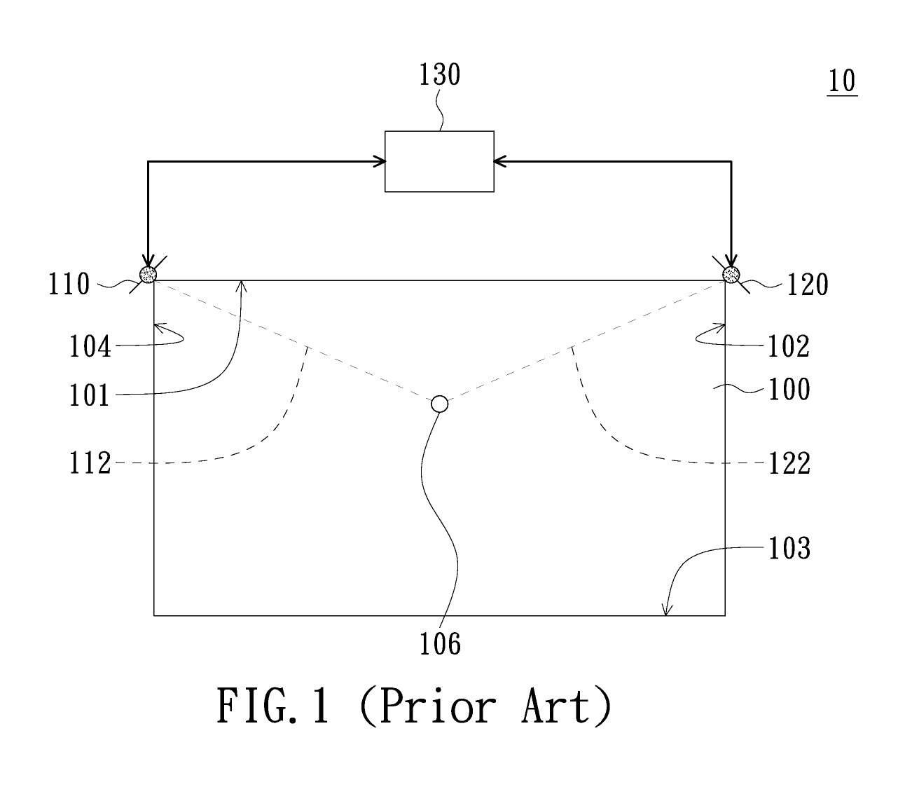

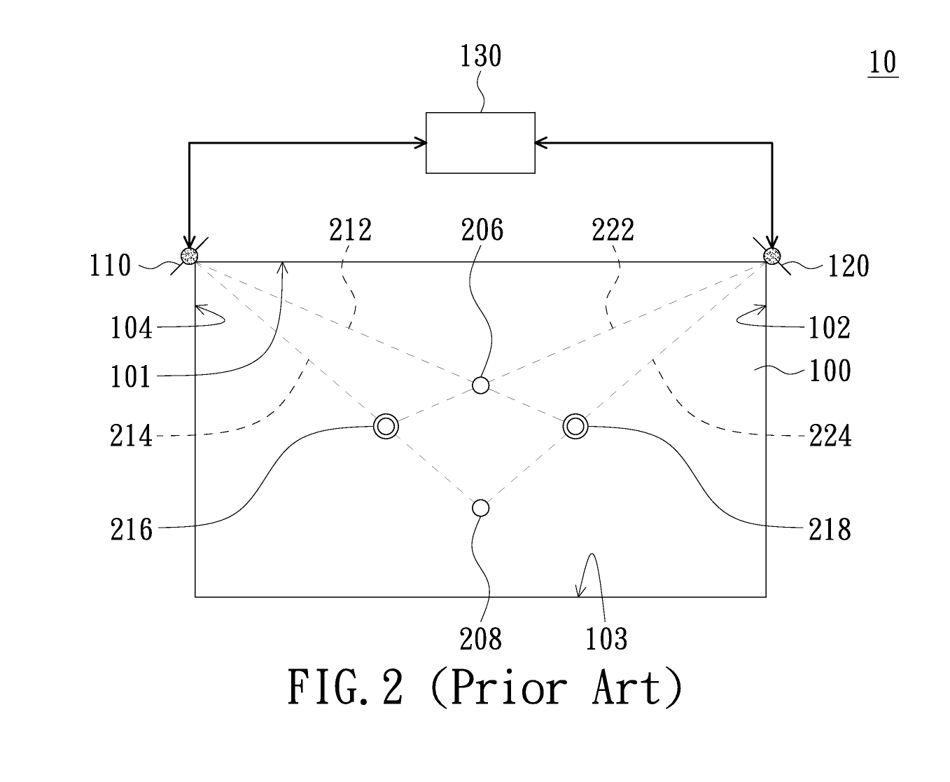

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

The touch-control system of the present invention includes at least two coordinate systems, which are implemented by respective pointer sensing modules. One pointer sensing module includes two image sensing apparatuses, and the extension lines of the centers of the sensing ranges of the two image sensing apparatuses are configured to have an angle therebetween. Another pointer sensing module includes two pointer sensing apparatuses, and the extension lines of the centers of the sensing ranges of the two pointer sensing apparatuses are configured to have another angle therebetween. By referring the possible coordinate positions of the pointers, calculated based on the pointer images sensed by one pointer sensing module, to as the first candidate coordinate group; the possible coordinate positions of the pointers, calculated based on the pointer information sensed by another pointer sensing module, to as the second candidate coordinate group; and calculating the intersection of the first and second candidate coordinate groups; the touch-control system of the present invention can efficiently distinguish the actual coordinate position of pointers from the ghost points through calculating the intersection of the candidate coordinate groups.

### First Embodiment

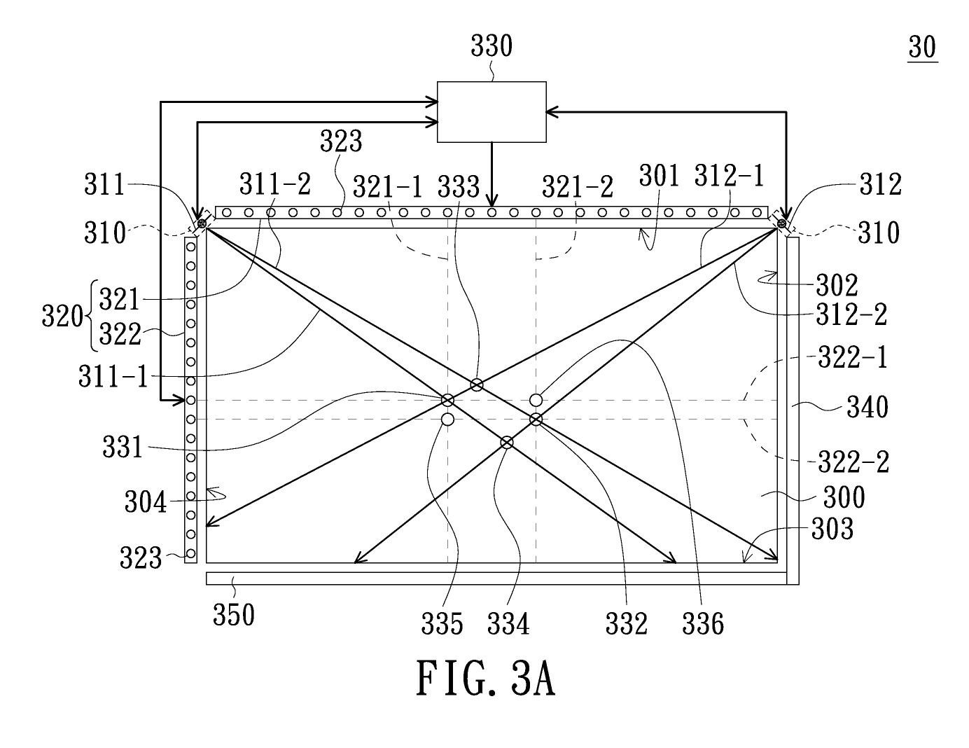

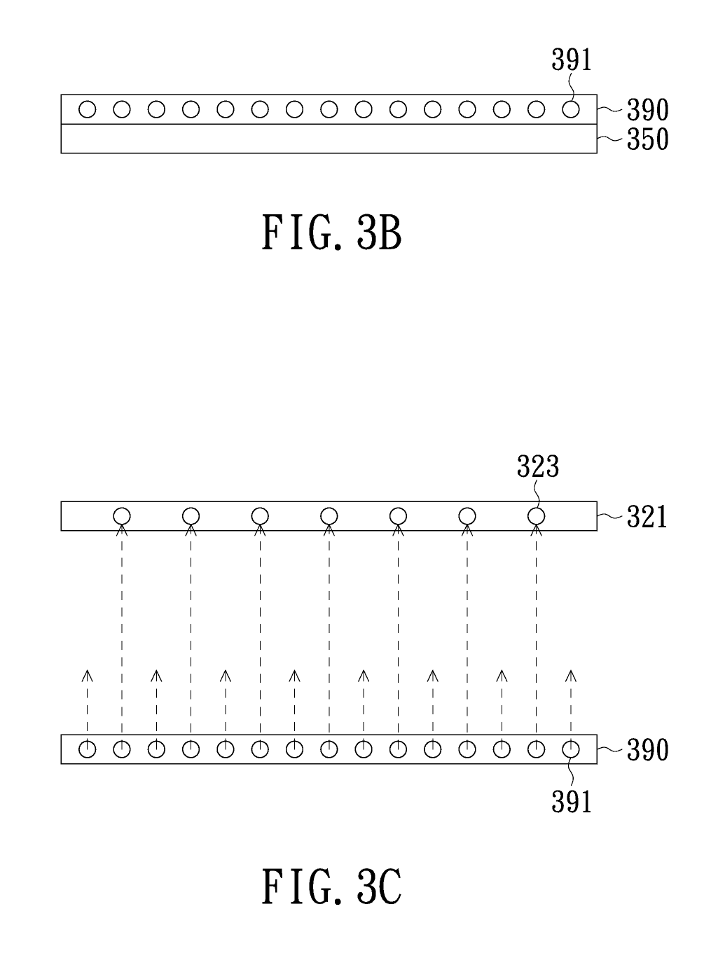

FIG. 3A is a schematic view of a touch-control system in accordance with the first embodiment of the present invention. As shown, the touch-control system 30 in this embodiment includes a touch-control panel 300, two pointer sensing modules 310, 320 and a processing circuit 330. The touch-control panel 300 is configured to have a quadrilateral structure, which is defined by a first side 301, a second side 302, a third side 303 and a fourth side 304 sequentially connected. The pointer sensing module 310 includes two image sensing apparatuses 311, 312. In one embodiment, the image sensing apparatus 311 is disposed in an corner resulted by the first side 301 and the fourth side 304; and the image sensing apparatus 312 is disposed in an corner resulted by the first side 301 and the second side 302. The image sensing apparatuses 311, 312 each are configured to have a respective sensing range, which is related to the width of an image captured by the respective image sensing apparatus. In one exemplary embodiment as illustrated in FIG. 3A, the extension line of the center of the sensing range of the image sensing apparatus 311 and that of the image sensing apparatus 312 are configured to have a first angle (e.g., 135 degrees) therebetween.

The pointer sensing module 320 includes two pointer sensing apparatuses, which are implemented by two photosensitive apparatuses 321, 322, respectively. The photosensitive apparatuses 321, 322 both include a plurality of photosensitive elements 323, each is configured to sense lights on the touch-control panel 300 and accordingly output a sensing signal (not shown). In one embodiment, the photosensitive apparatuses 321, 322 are disposed on the first side 301 and the fourth side 304 of the touch-control panel 300, respectively; and the present invention is not limited thereto. In other words, to those ordinarily skilled in the art it is understood the photosensitive apparatuses 321, 322 may be disposed on any connected two of the first side 301, the second side 302, the third side 303 and the fourth side 304 of the touch-control panel 300. The photosensitive apparatuses 321, 322 each are configured to have a respective sensing range, which is the sum of the sensing ranges of all the corresponding individual photosensitive elements 323 therein. In one exemplary embodiment as illustrated in FIG. 3A, the extension line of the center of the sensing range of the photosensitive apparatus 321 and that of the photosensitive apparatus 322 are configured to have a second angle (e.g., 90 degrees) therebetween.

The processing circuit 330, electrically coupled to the image sensing apparatuses 311, 312, is configured to control the operations of the image sensing apparatuses 311, 312 and receive the pointer images sensed by the image sensing apparatuses 311, 312. In addition, the processing circuit 330 is further electrically coupled to each photosensitive element 323 and further configured to control the operation of each photosensitive element 323, from which to receive the sensing signal and thereby concluding all individual sensing signals as one set of pointer information.

In one actual operation, the processing circuit 330 is configured to, when the touch-control panel 300 is being touched by the pointers 331, 332, calculate the possible coordinate positions of the pointers 331, 332 according to the pointer images sensed by the pointer sensing module 310; wherein the calculated possible coordinate positions of the pointers 331, 332 derived from the pointer sensing module 310 herein are referred to as the first candidate coordinate group. Specifically, the image sensing apparatus 311 of the pointer sensing module 310 is configured to sense the pointers 331, 332 along the sensing paths 311-1, 311-2, respectively; and the image sensing apparatus 312 of the pointer sensing module 310 is configured to sense the pointers 331, 332 along the sensing paths 312-1, 312-2, respectively. In addition, the processing circuit 330 is configured to calculate the possible coordinate positions of the pointers 331, 332 according to the four crossing points resulted by the four sensing paths 311-1, 311-2, 312-1 and 312-2. It is to be noted that the four positions, indicated by the four labels 331, 332, 333, 334 and resulted by the four sensing paths 311-1, 311-2, 312-1 and 312-2, together are referred to as the first candidate coordinate group due to the two positions indicated by the labels 333, 334 herein are also assumed, by the processing circuit 330, as the possible positions of the pointers 331, 332.

In addition, the processing circuit 330 is further configured to, when the touch-control panel 300 is being touched by the pointers 331, 332, calculate the possible coordinate positions of the pointers 331, 332 according to the pointer information obtained from the pointer sensing module 320; wherein the calculated possible coordinate positions of the pointers 331, 332 derived from the pointer sensing module 320 herein are referred to as the second candidate coordinate group. Specifically, the photosensitive apparatus 321 of the pointer sensing module 320 is configured to sense the pointers 331, 332 along the sensing paths 321-1, 321-2, respectively; and the photosensitive apparatus 322 of the pointer sensing module 320 is configured to sense the pointers 331, 332 along the sensing paths 322-1, 322-2, respectively. Consequentially, the processing circuit 330 is configured to refer the sensing signals from the photosensitive apparatus 321 to as one set of pointer information; the sensing signals from the photosensitive apparatus 322 to as another one set of pointer information; further obtain the four sensing paths 321-1, 321-2, 322-1 and 322-2 according to the aforementioned two sets set of pointer information; and calculate the possible coordinate positions of the pointers 331, 332 according to the four crossing points resulted by the four sensing paths 321-1, 321-2, 322-1 and 322-2. It is to be noted that the four positions, indicated by the four labels 331, 332, 335, 336 and resulted by the four sensing paths 321-1, 321-2, 322-1 and 322-2, together are referred to as the second candidate coordinate group due to the two positions indicated by the labels 335, 335 herein are also assumed, by the processing circuit 330, as the possible positions of the pointers 331, 332.

As illustrated in FIG. 3A, the first and second candidate coordinate groups both includes the actual coordinate positions of the pointers 331, 332. Specifically, in the first candidate coordinate group, the two crossing points indicated by the labels 331, 332, are resulted from the pointers 331, 332 and the remained crossing points (e.g., indicated by the labels 333, 334) are resulted from the ghost points; and in the second candidate coordinate group, the two crossing points indicated by the labels 331, 332, are resulted from the pointers 331, 332 and the remained crossing points (e.g., indicated by the labels 335, 336) are resulted from the ghost points. Accordingly, the processing circuit 330 is further configured to calculate the intersection of the first and second candidate coordinate groups and thereby determining the actual coordinate positions of the pointers 331, 332 by the elements in the intersection. Thus, the touch-control system 30 in this embodiment is prevented from being affected by the ghost points, which may consequentially lead to a wrong determination of the coordinate positions of the pointers 331, 332. In one embodiment, the mean of calculating, by the processing circuit 330, the intersection of the first and second candidate coordinate groups may be realized by steps of: determining that whether or not there exist a coordinate position in the first candidate coordinate group having a distance, respective to one coordinate position in the second candidate coordinate group, less than a predetermined distance; and referring the pair of coordinate positions in the first and second candidate coordinate groups having a distance therebetween less than the predetermined distance as one element in the intersection of the first and second candidate coordinate groups. Alternatively, in another embodiment it is understood that the mean of calculating, by the processing circuit 330, the intersection of the first and second candidate coordinate groups may be realized by steps of: determining that whether or not there exist a coordinate position in the second candidate coordinate group having a distance, respective to one coordinate position in the first candidate coordinate group, less than a predetermined distance; and referring the pair of coordinate positions in the first and second candidate coordinate groups having a distance therebetween less than the predetermined distance as one element in the intersection of the first and second candidate coordinate groups.

In one preferable embodiment, the touch-control system 30 may further include at least three illuminating apparatuses disposed on three of the first side, 301, the second side 302, the third side 303 and the fourth side 304, respectively, and configured to illuminate toward the image sensing apparatuses 311, 312. In the exemplary embodiment as illustrated in FIG. 3A, the touch-control system 30 includes a first illuminating apparatus 340, disposed on the second side 302, a second illuminating apparatus 350, disposed on the third side 303, and a third illuminating apparatus (not shown), superimposed on the photosensitive apparatus 322. In other words, if any side of the touch-control panel 300 is disposed with an illuminating apparatus and a photosensitive apparatus both, the illuminating apparatus and the photosensitive apparatus are required to be superimposed to each other. In one embodiment, the aforementioned illuminating apparatus may be replaced by a reflective apparatus capable of reflecting lights toward the image sensing apparatuses 311, 312. And accordingly, the aforementioned image sensing apparatuses 311, 312 each are required to be disposed with an infra-red (IR) illuminating apparatus, which is implemented by one or more IR light emitting diodes (LEDs) for example. In addition, the aforementioned image sensing apparatuses 311, 312 each are required to be disposed with an IR-pass apparatus (e.g., IR-pass filter) capable of being passed by IR only; thus, the aforementioned image sensing apparatuses 311, 312 can capture the image on the touch-control panel 300 via the IR-pass apparatus.

It is to be noted that the image sensing apparatuses 311, 312 may corporately use one illuminating apparatus, or, each have one individual illuminating apparatus. For example, the image sensing apparatuses 311, 312 may corporately use one IR illuminating apparatus, which may be disposed on the first side 301 of the touch-control panel 300 in the touch-control system 30, if the image sensing apparatuses 311, 312 neither have the IR illuminating apparatus therein but both have the IR-pass apparatus. In addition, it is understood that this illuminating apparatus is required to be superimposed on the photosensitive apparatus 321.

Furthermore, to increase the sensing efficiency of the photosensitive apparatuses 321, 322, the touch-control system 30 in one embodiment may further include one or more rows of single-point illuminating apparatuses on one or more sides of the touch-control panel 300. For example, in one embodiment, the touch-control panel 300 may be further disposed with one row of single-point illuminating apparatuses on the second side 302 thereof and one row of single-point illuminating apparatuses on the third side 303 thereof. The aforementioned each single-point illuminating apparatus may be implemented by a light-emitting device. In addition, the row of single-point illuminating apparatus and the illuminating apparatus (or, the reflective apparatus) may have a superimposing arrangement if the two are disposed on the same side of the touch-control panel 300. For example, as illustrated in FIG. 3B, if the illuminating apparatus 350 and the illuminating module 390 both are disposed on the third side 303 of the touch-control panel 300, the illuminating module 390 may be disposed on the top of the illuminating apparatus 350; wherein the illuminating module 390 includes one row of single-point illuminating apparatuses 391. In one preferred embodiment, the single-point illuminating apparatuses 391 in the illuminating module 390 and the photosensitive elements 323 in the photosensitive apparatus 321 are arranged in a one-to-one correspondence manner. It is understood that the illuminating apparatus 350 may be disposed on the top of the illuminating module 390 in another embodiment.

It is to be noted that the illuminating apparatus 350 in FIG. 3B may be omitted if the single-point illuminating apparatuses 391 are arranged concentrately enough in the illuminating module 390 and each one of the photosensitive element 323 in the photosensitive apparatus 321 is corresponding to one respective single-point illuminating apparatus 391 in the illuminating module 390. As illustrated in FIG. 3C, the illuminating apparatus 350 is omitted due to that each one of the photosensitive element 323 in the photosensitive apparatus 321 is corresponding to one respective single-point illuminating apparatus 391 in the illuminating module 390; wherein the photosensitive apparatus 321 is disposed on the first side 301 of the touch-control panel 300 and the illuminating module 390 is disposed on the third side 303 of the touch-control panel 300.

### Second Embodiment

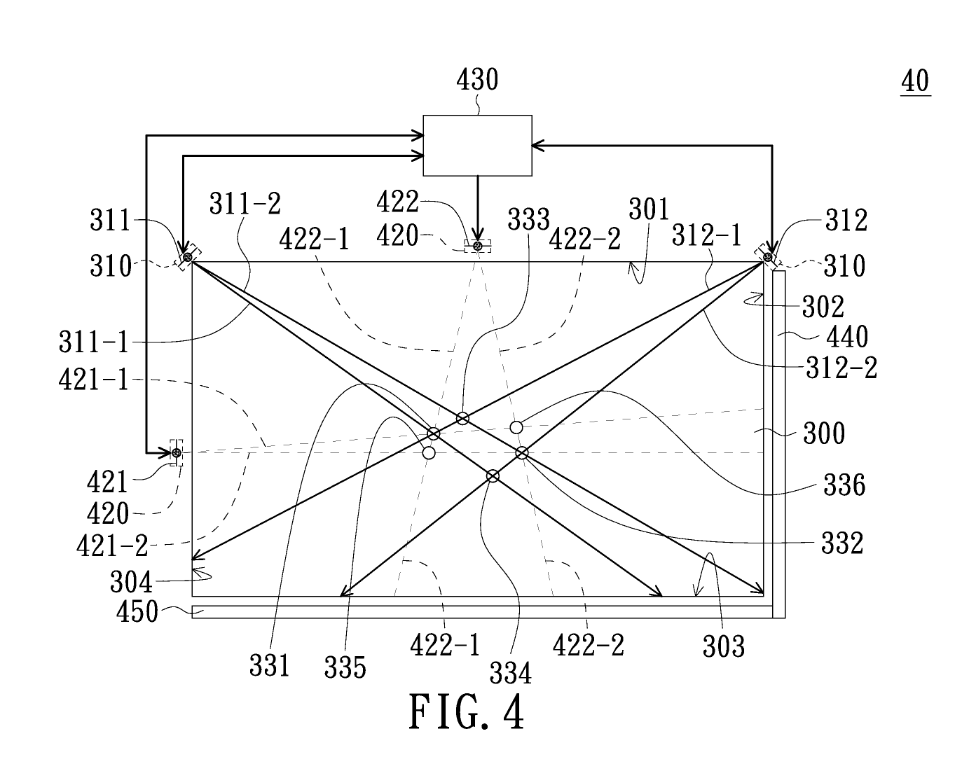

FIG. 4 is a schematic view of a touch-control system in accordance with the second embodiment of the present invention; wherein the objects labeled with the same number (or mark) in FIGS. 4, 3A represent the same device (or, element, apparatus). Same as the touch-control system 30 in the first embodiment, the touch-control system 40 in this embodiment also employs two pointer sensing modules 310, 420. The main difference between the touch-control system 40 shown in FIG. 4 and the touch-control system 30 shown in FIG. 3A is that the two pointer sensing apparatuses in the pointer sensing module 420 in the touch-control system 40 are implemented by the image sensing apparatuses 421, 422, respectively.

In one exemplary embodiment as illustrated in FIG. 4, the extension line of the center of the sensing range of the image sensing apparatus 311 and that of the image sensing apparatus 312 are configured to have the first angle (e.g., 135 degrees) therebetween. The image sensing apparatuses 421, 422 are disposed on the fourth side 304 and the first side 301 of the touch-control panel 300, respectively; and the extension line of the center of the sensing range of the image sensing apparatus 421 and that of the image sensing apparatus 422 are configured to have the second angle (e.g., 90 degrees) therebetween. The present invention is not limited to the aforementioned arrangement of the image sensing apparatuses 421, 422; in other words, to those ordinarily skilled in the art it is understood the image sensing apparatuses 421, 422 may be disposed on any connected two of the first side 301, the second side 302, the third side 303 and the fourth side 304 of the touch-control panel 300.

As illustrated in FIG. 4, the processing circuit 430 is electrically coupled to the image sensing apparatuses 311, 312, 421 and 422. In one actual operation, the processing circuit 430 is configured to, when the touch-control panel 300 is being touched by the pointers 331, 332, calculate the possible coordinate positions of the pointers 331, 332 according to the pointer images sensed by the pointer sensing module 310; wherein the calculated possible coordinate positions of the pointers 331, 332 derived from the pointer sensing module 310 herein are referred to as the first candidate coordinate group. In addition, the processing circuit 430 is further configured to calculate the possible coordinate positions of the pointers 331, 332 according to the pointer information obtained from the pointer sensing module 420; wherein the calculated possible coordinate positions of the pointers 331, 332 derived from the pointer sensing module 420 herein are referred to as the second candidate coordinate group. Specifically, the image sensing apparatus 421 of the pointer sensing module 420 is configured to sense the pointers 331, 332 along the sensing paths 421-1, 421-2, respectively; and the image sensing apparatus 422 of the pointer sensing module 420 is configured to sense the pointers 331, 332 along the sensing paths 422-1, 422-2, respectively. Accordingly, by referring each pointer image sensed by the image sensing apparatuses 421, 422 to as a pointer information, the processing circuit 430 can obtain the sensing paths 421-1, 421-2, 422-1 and 422-2 according to the pointer information, calculate the crossing points resulted by the sensing paths 421-1, 421-2, 422-1 and 422-2 and thereby referring the crossing points to as the second candidate coordinate group.

As illustrated in FIG. 4, the first and second candidate coordinate groups both includes the actual coordinate positions of the pointers 331, 332. Specifically, in the first candidate coordinate group, the two crossing points indicated by the labels 331, 332, are resulted from the pointers 331, 332 and the remained crossing points (e.g., indicated by the labels 333, 334) are resulted from the ghost points; and in the second candidate coordinate group, the two crossing points indicated by the labels 331, 332, are resulted from the pointers 331, 332 and the remained crossing points (e.g., indicated by the labels 335, 336) are resulted from the ghost points. Accordingly, the processing circuit 430 is further configured to calculate the intersection of the first and second candidate coordinate groups and thereby determining the actual coordinate positions of the pointers 331, 332 by the elements in the intersection. Thus, the touch-control system 40 in this embodiment is prevented from being affected by the ghost points, which may consequentially lead to a wrong determination of the coordinate positions of the pointers 331, 332.

In one preferable embodiment, the touch-control system 40 may further include at least three illuminating apparatuses disposed on three of the first side, 301, the second side 302, the third side 303 and the fourth side 304, respectively, and configured to illuminate toward the image sensing apparatuses 311, 312. In the exemplary embodiment as illustrated in FIG. 4, the touch-control system 40 includes a first illuminating apparatus 440, disposed on the second side 302, a second illuminating apparatus 450, disposed on the third side 303, and a third illuminating apparatus (not shown), superimposed on the image sensing apparatus 421. In other words, if any side of the touch-control panel 300 is disposed with an illuminating apparatus and an image sensing apparatus both, the illuminating apparatus and the image sensing apparatus are required to be superimposed to each other. In one embodiment, the aforementioned illuminating apparatus may be replaced by a reflective apparatus capable of reflecting lights toward the image sensing apparatuses 311, 312. And accordingly, the aforementioned image sensing apparatuses 311, 312 each are required to be disposed with an IR illuminating apparatus, which is implemented by one or more IR LEDs for example. In addition, the aforementioned image sensing apparatuses 311, 312 each are required to be disposed with an IR-pass apparatus (e.g., IR-pass filter) capable of being passed by IR only; thus, the aforementioned image sensing apparatuses 311, 312 can capture the image on the touch-control panel 300 via the IR-pass apparatus.

In another embodiment, besides being configured to obtain the first set of image information of the pointers 331, 332, the pointer sensing module 310 of the touch-control system 40 is further configured to calculate the first candidate coordinate group of the pointers 331, 332 according to the first set of image information. Compared with the pointer sensing module 310, the pointer sensing module 420 is configured to obtain the second set of image information of the pointers 331, 332 only. Accordingly, the processing circuit 430 is configured to select two or more elements in the first candidate coordinate group according to the second set of image information to as the actual coordinate positions of the pointers 331, 332.

### Third Embodiment

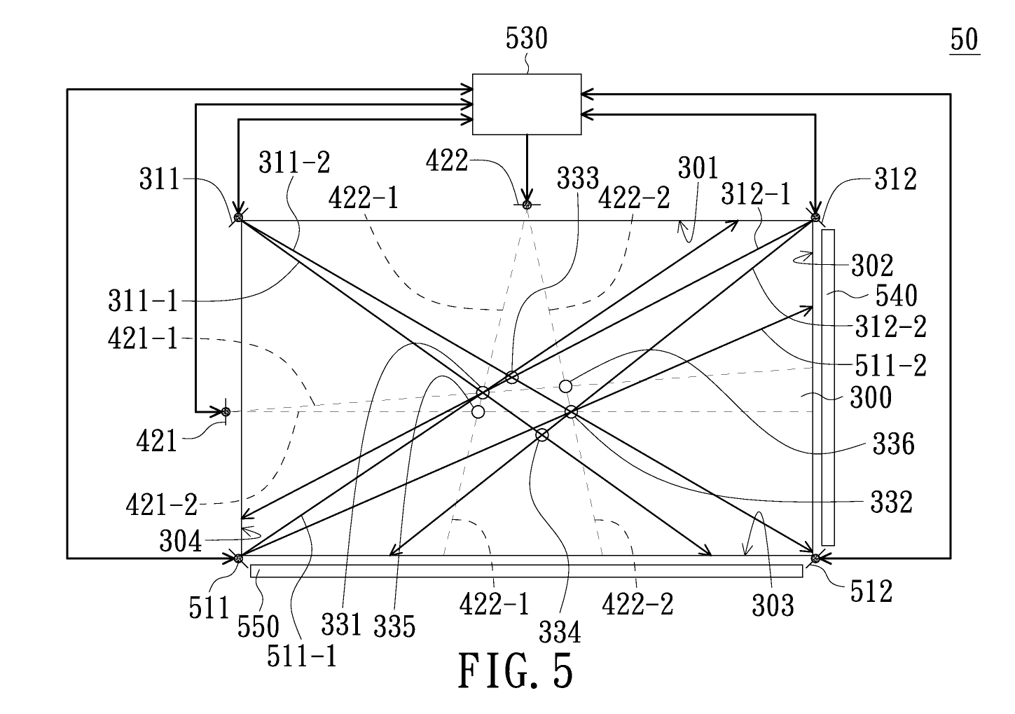

FIG. 5 is a schematic view of a touch-control system in accordance with the third embodiment of the present invention; wherein the objects labeled with the same number (or mark) in FIGS. 4, 5 represent the same device (or, element, apparatus). The main difference between the touch-control system 50 shown in FIG. 5 and the touch-control system 40 shown in FIG. 4 is that the touch-control system 50 further includes image sensing apparatuses 511, 512, besides the image sensing apparatuses 311, 312, 421 and 422; wherein the image sensing apparatuses 511, 512 are included in the third pointer sensing module. The image sensing apparatus 511 is disposed in the corner resulted by the third side 303 and the fourth side 304 of the touch-control panel 300 and accordingly is adjacent to the image sensing apparatus 311; and the image sensing apparatus 512 is disposed in the corner resulted by the third side 303 and the second side 302 of the touch-control panel 300 and accordingly is adjacent to the image sensing apparatus 312.

In one exemplary embodiment as illustrated in FIG. 5, the extension line of the center of the sensing range of the image sensing apparatus 311 and that of the image sensing apparatus 312 are configured to have the first angle (e.g., 135 degrees) therebetween; the extension line of the center of the sensing range of the image sensing apparatus 421 and that of the image sensing apparatus 422 are configured to have the second angle (e.g., 90 degrees) therebetween; the extension line of the center of the sensing range of the image sensing apparatus 511 and that of the image sensing apparatus 311 are configured to have a third angle (e.g., 45 degrees) therebetween; and the extension line of the center of the sensing range of the image sensing apparatus 512 and that of the image sensing apparatus 312 are configured to have the third angle therebetween.

As illustrated in FIG. 5, the processing circuit 530 is electrically coupled to the image sensing apparatuses 311, 312, 421, 422, 511 and 512. In one actual operation, the processing circuit 530 is configured to, when the touch-control panel 300 is being touched by the pointers 331, 332, calculate the crossing points resulted by the sensing paths 311-1, 311-2, 312-1 and 312-2 according to the pointer images sensed by the image sensing apparatuses 311, 312 and refer the aforementioned calculated crossing points to as the first candidate coordinate group. In addition, the processing circuit 530 is further configured to calculate the crossing points resulted by the sensing paths 421-1, 421-2, 422-1 and 422-2 according to the pointer images sensed by the image sensing apparatuses 421, 422 and refer the aforementioned calculated crossing points to as the second candidate coordinate group. In addition, the processing circuit 530 is further configured to calculate the crossing points resulted by the sensing paths 311-1, 311-2, 511-1 and 511-2 according to the pointer images sensed by the image sensing apparatuses 311, 511 and refer the aforementioned calculated crossing points to as the third candidate coordinate group. In another embodiment, the processing circuit 530 may be configured to calculate the crossing points resulted by the associated sensing paths according to the pointer images sensed by the image sensing apparatuses 312, 512 and refer the aforementioned calculated crossing points to as the third candidate coordinate group.

As illustrated in FIG. 5, the first, second and third candidate coordinate groups all includes the actual coordinate positions of the pointers 331, 332. Specifically, in the first candidate coordinate group, the two crossing points indicated by the labels 331, 332, are resulted from the pointers 331, 332 and the remained crossing points (e.g., indicated by the labels 333, 334) are resulted from the ghost points; in the second candidate coordinate group, the two crossing points indicated by the labels 331, 332, are resulted from the pointers 331, 332 and the remained crossing points (e.g., indicated by the labels 335, 336) are resulted from the ghost points; and in the third candidate coordinate group, the two crossing points indicated by the labels 331, 332, are resulted from the pointers 331, 332 and the remained crossing points are resulted from the ghost points. Accordingly, the processing circuit 530 is further configured to calculate the intersection of the first, second and third candidate coordinate groups and thereby determining the actual coordinate positions of the pointers 331, 332 by the elements in the intersection. Thus, the touch-control system 50 in this embodiment is prevented from being affected by the ghost points, which may consequentially lead to a wrong determination of the coordinate positions of the pointers 331, 332.

In one preferable embodiment, the touch-control system 50 may further include four illuminating apparatuses disposed on the first side, 301, the second side 302, the third side 303 and the fourth side 304, respectively, and configured to illuminate toward the image sensing apparatuses 311, 312. In the exemplary embodiment as illustrated in FIG. 5, the touch-control system 50 includes a first illuminating apparatus 540, disposed on the second side 302, a second illuminating apparatus 550, disposed on the third side 303, and third and fourth illuminating apparatuses (not shown), superimposed on the image sensing apparatuses 421, 422, respectively. In one embodiment, the aforementioned illuminating apparatus may be replaced by a reflective apparatus capable of reflecting lights toward the image sensing apparatuses 311, 312. And accordingly, the aforementioned image sensing apparatuses 311, 312 each are required to be disposed with an IR illuminating apparatus, which is implemented by one or more IR LEDs for example. In addition, the aforementioned image sensing apparatuses 311, 312 each are required to be disposed with an IR-pass apparatus (e.g., IR-pass filter) capable of being passed by IR only; thus, the aforementioned image sensing apparatuses 311, 312 can capture the image on the touch-control panel 300 via the IR-pass apparatus.

In summary, by establishing a plurality of coordinate systems and accordingly generating respective candidate coordinate groups, the touch-control system of the present invention can efficiently distinguish the actual coordinate position of pointers from the ghost points through calculating the intersection of the candidate coordinate groups.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch-control system, comprising:
a touch-control panel;
a first pointer sensing module, comprising:
a first image sensing apparatus; and
a second image sensing apparatus, wherein an extension line of a center of a sensing range of the first image sensing apparatus and that of the second image sensing apparatus are configured to have a first angle therebetween;
a second pointer sensing module, comprising:
a first pointer sensing apparatus disposed on a side of the touch-control panel; and
a second pointer sensing apparatus disposed on a side of the touch-control panel, wherein the extension line of the center of the sensing range of the first pointer sensing apparatus and that of the second pointer sensing apparatus are configured to have a second angle therebetween; and
a processing circuit electrically coupled to the first and second pointer sensing modules, wherein the processing circuit is configured to, when the touch-control panel is being touched by a first pointer and a second pointer, calculate possible coordinate positions of the first and second pointers according to pointer images sensed by the first pointer sensing module and thereby referring the calculated possible coordinate positions of the first and second pointers derived from the first pointer sensing module to as a first candidate coordinate group; the processing circuit is further configured to calculate possible coordinate positions of the first and second pointers according to pointer information sensed by the second pointer sensing module and thereby referring the calculated possible coordinate positions of the first and second pointers derived from the second pointer sensing module to as a second candidate coordinate group; and the processing circuit is further configured to obtain an intersection of the first and second candidate coordinate groups and thereby referring elements in the intersection to as the actual coordinate positions of the first and second pointers.

2. The touch-control system according to claim 1, wherein a mean of obtaining, by the processing circuit, the intersection of the first and second candidate coordinate groups comprises steps of:
determining that whether or not there exist a coordinate position in the first candidate coordinate group having a distance, respective to one coordinate position in the second candidate coordinate group, less than a predetermined distance; and
referring the pair of coordinate positions in the first and second candidate coordinate groups having a distance therebetween less than the predetermined distance to as one element in the intersection of the first and second candidate coordinate groups.

3. The touch-control system according to claim 1, wherein a mean of obtaining, by the processing circuit, the intersection of the first and second candidate coordinate groups comprises steps of:
determining that whether or not there exist a coordinate position in the second candidate coordinate group having a distance, respective to one coordinate position in the first candidate coordinate group, less than a predetermined distance; and
referring the pair of coordinate positions in the first and second candidate coordinate groups having a distance therebetween less than the predetermined distance to as one element in the intersection of the first and second candidate coordinate groups.

4. The touch-control system according to claim 1, wherein the touch-control panel is configured to have a quadrilateral structure, which is defined by a first side, a second side, a third side and a fourth side sequentially connected.

5. The touch-control system according to claim 4, wherein the first image sensing apparatus is disposed in an corner resulted by the first and fourth sides, and the second image sensing apparatus is disposed in an corner resulted by the first and second sides.

6. The touch-control system according to claim 5, wherein the first and second pointer sensing apparatuses are implemented by a first and second photosensitive apparatuses, respectively, the first and second photosensitive apparatuses are disposed on any connected two of the first, second, third and fourth sides of the touch-control panel, respectively, the first and second photosensitive apparatuses both include a plurality of photosensitive elements, each is configured to sense lights on the touch-control panel and accordingly output a respective sensing signal, the processing circuit is further configured to refer the sensing signals outputted from the first and second photosensitive apparatuses to as the pointer information and thereby obtaining the second candidate coordinate group based on the pointer information.

7. The touch-control system according to claim 6, further comprising at least three illuminating apparatuses disposed on any three of the first, second, third and fourth sides of the touch-control panel, respectively, and configured to illuminate toward the touch-control panel, wherein the illuminating apparatus and the photosensitive apparatus are arranged to be superimposed to each other if both are disposed on the same side of the touch-control panel.

8. The touch-control system according to claim 6, further comprising at least three reflective apparatuses disposed on any three of the first, second, third and fourth sides of the touch-control panel, respectively, and configured to reflect lights toward the touch-control panel, wherein the reflective apparatus and the photosensitive apparatus are arranged to be superimposed to each other if both are disposed on the same side of the touch-control pane, the first and second image sensing apparatuses each comprise an infra-red (IR) illuminating apparatus and an IR-pass apparatus, and the first and second image sensing apparatuses are configured to capture images on the touch-control panel via the IR-pass apparatus.

9. The touch-control system according to claim 5, wherein the first and second pointer sensing apparatuses are implemented by a third and fourth image sensing apparatuses, respectively, the third and fourth image sensing apparatuses are disposed on any connected two of the first, second, third and fourth sides of the touch-control panel, respectively, the processing circuit is further configured to refer the pointer images sensed by the third and fourth image sensing apparatuses to as the pointer information and thereby obtaining the second candidate coordinate group based on the pointer information.

10. The touch-control system according to claim 9, further comprising at least three illuminating apparatuses disposed on any three of the first, second, third and fourth sides of the touch-control panel, respectively, and configured to illuminate toward the touch-control panel, wherein the illuminating apparatus and the image sensing apparatus are arranged to be superimposed to each other if both are disposed on the same side of the touch-control panel.

11. The touch-control system according to claim 9, further comprising at least three reflective apparatuses disposed on any three of the first, second, third and fourth sides of the touch-control panel, respectively, and configured to reflect lights toward the touch-control panel, wherein the reflective apparatus and the image sensing apparatus are arranged to be superimposed to each other if both are disposed on the same side of the touch-control pane, the first and second image sensing apparatuses each comprise an infra-red (IR) illuminating apparatus and an IR-pass apparatus, and the first and second image sensing apparatuses are configured to capture images on the touch-control panel via the IR-pass apparatus.

12. The touch-control system according to claim 9, further comprising a third pointer sensing module, the third pointer sensing module comprising:
a fifth image sensing apparatus disposed in a corner resulted by the third and fourth sides of the touch-control panel; and
a sixth image sensing apparatus disposed in a corner resulted by the second and third sides of the touch-control panel.

13. The touch-control system according to claim 5, wherein the first pointer sensing apparatus is implemented by either the first or the second image sensing apparatus, the second pointer sensing apparatus is implemented by a third image sensing apparatus, the third image sensing apparatus is disposed either in a corner resulted by the second and third sides or a corner resulted by the third and fourth sides of the touch-control panel, the third image sensing apparatus and the image sensing apparatus in the first pointer sensing apparatus are disposed in the two adjacent corners of the touch-control panel, respectively, the processing circuit is further configured to refer the pointer images sensed by the image sensing apparatus in the first pointer sensing apparatus and the third image sensing apparatus to as the pointer information and thereby obtaining the second candidate coordinate group based on the pointer information.

14. The touch-control system according to claim 13, further comprising four illuminating apparatuses disposed on any the first, second, third and fourth sides of the touch-control panel, respectively, and configured to illuminate toward the touch-control panel, wherein the illuminating apparatus and the image sensing apparatus are arranged to be superimposed to each other if both are disposed on the same side of the touch-control panel.

15. The touch-control system according to claim 13, further comprising four reflective apparatuses disposed on the first, second, third and fourth sides of the touch-control panel, respectively, and configured to reflect lights toward the touch-control panel, wherein the reflective apparatus and the image sensing apparatus are arranged to be superimposed to each other if both are disposed on the same side of the touch-control pane, each image sensing apparatus comprises an infra-red (IR) illuminating apparatus and an IR-pass apparatus, and each image sensing apparatus is configured to capture images on the touch-control panel via the IR-pass apparatus.

16. A touch-control system adapted to be used with a plurality of pointers, the touch-control system comprising:
a touch-control panel;
a first pointer sensing module configured to sense a first set of image information of the pointers and accordingly calculate a first candidate coordinate group of the pointers;
a second pointer sensing module configured to sense a second set of image information of the pointers; and
a processing circuit electrically coupled to the first and second pointer sensing modules and configured to select, according to the second set of image information, two or more coordinate positions in the first candidate coordinate group to as actual coordinate positions of the pointers.

17. The touch-control system according to claim 16, wherein the first pointer sensing module comprises:
a first image sensing apparatus disposed on a side of the touch-control panel; and
a second image sensing apparatus disposed on a side of the touch-control panel, wherein an extension line of a center of a sensing range of the first image sensing apparatus and that of the second image sensing apparatus are configured to have a first angle therebetween.

18. The touch-control system according to claim 17, wherein the second pointer sensing module comprises:
a first pointer sensing apparatus disposed on a side of the touch-control panel; and
a second pointer sensing apparatus disposed on a side of the touch-control panel, wherein the extension line of the center of the sensing range of the first pointer sensing apparatus and that of the second pointer sensing apparatus are configured to have a second angle therebetween.
